(19) United States
(12) Patent Application Publication
(10) Pub. No.: US 2009/0302187 A1
(43) Pub. Date: Dec. 10, 2009

(54) STREAMER SUPPORT COLLAR

(76) Inventor: Robin F. Denman, Naples, FL (US)

Correspondence Address: FRASER CLEMENS MARTIN & MILLER LLC, 28366 KENSINGTON LANE, PERRYSBURG, OH, 43551, US

(21) Appl. No.: 12/475,874

(22) Filed: Jun. 1, 2009

Related U.S. Application Data
(60) Provisional application No. 61/060,150, filed on Jun. 10, 2008.

(51) Int. Cl. F16M 13/00

(52) U.S. Cl. 248/535

(57) ABSTRACT

A streamer staff holder is disclosed comprised of an adjustable collar for surrounding a supporting columnar member. Means are provided to selectively tighten or loosen the collar permitting the collar to be mounted on the columnar member. A plurality of spaced apart hollow sleeves are secured to a surface of the collar and are employed to receive and retain one end of a streamer supporting staff.

### CROSS-REFERENCE TO RELATED APPLICATION

This application claims the benefit of U.S. Provisional Patent Application Ser. No. 61/060,150 filed on Jun. 10, 2008.

### FIELD OF THE INVENTION

The present invention relates to a new and useful improvement in holders for streamer staffs wherein a holder may be quickly applied to a tree trunk, mast, pole, or standard of any ordinary dimension.

### SUMMARY OF THE INVENTION

It is an object of the invention to produce a holder for streamer staffs which quickly adjust to a standard of different dimensions and tightly clamped in position.

Another one of the objects of the invention is to produce a holder for streamers comprising a collar or strap of metal that may be quickly adjusted to a pole or standard wherein a plurality of sockets are mounted on the strap or collar to receive staffs for the streamers.

Still another object of the invention is to produce a holder including an adjustment collar having a plurality of sockets so that when the collar is placed about the pole or standard the sockets may secure one end of the staffs containing streamers.

Still another object of the invention is to produce a collar or band having a plurality of sockets or retaining means extending therefrom so that the sockets may contain the proximal end of a staff and a streamer is attached to the other or distal end of the staff.

Still another object of the invention is to produce a holder for a staff containing a streamer comprising a collar which may be quickly and readily attached to any pole or standard and the collar is provided with a plurality of sockets extending therefrom and each adapted to receive one end of a staff containing a streamer.

Still another object of the invention is to produce a holder for streamers that is exceedingly inexpensive to manufacture, may be quickly and readily assembled, and adjustable to either large or small diameter poles, masts, or trees without the requirement for special tools.

With these and other objects in view the invention consists in certain new and novel arrangements and combination of parts as will be hereinafter more fully described and pointed out in the appended claims.

### BRIEF DESCRIPTION OF THE DRAWINGS

The above, as well as other objects and advantages of the invention, will become readily apparent to those skilled in the art from the following detailed description of the preferred embodiment of the invention when considered in the light of the attached drawings, in which:

FIG. 1 is a perspective view of the invention;

FIG. 2 is a top plan view of the invention illustrated in FIG. 1;

FIG. 3 is a front elevational view of the invention illustrated in FIG. 2; and

FIG. 4 is a side elevational view of the invention illustrated in FIG. 2.

### DETAILED DESCRIPTION OF A PREFERRED EMBODIMENT OF THE INVENTION

Referring now more specifically to the several figures and to the preferred form of the invention, there is shown a strap or collar which may be of an alloy containing aluminum or other suitable material.

It will be understood that before the straps or collars are applied to the pole, mast, or tree, the straps or collars are in strip form or flat throughout their length.

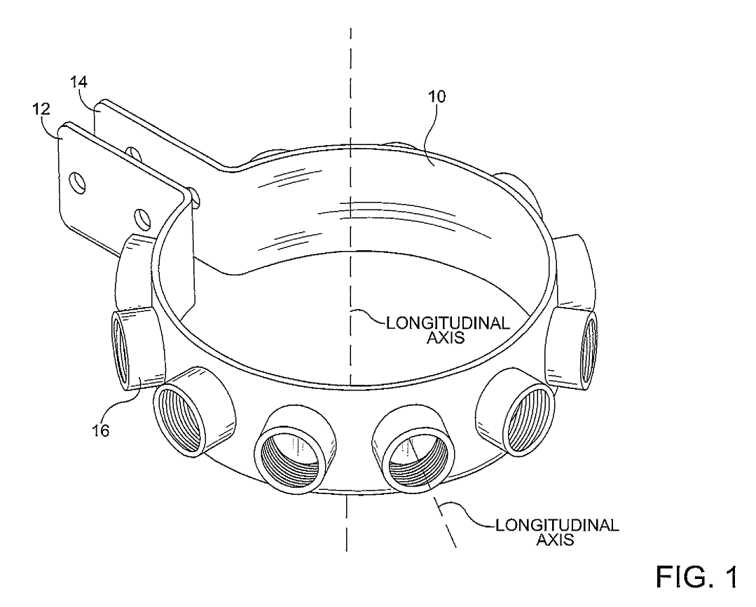

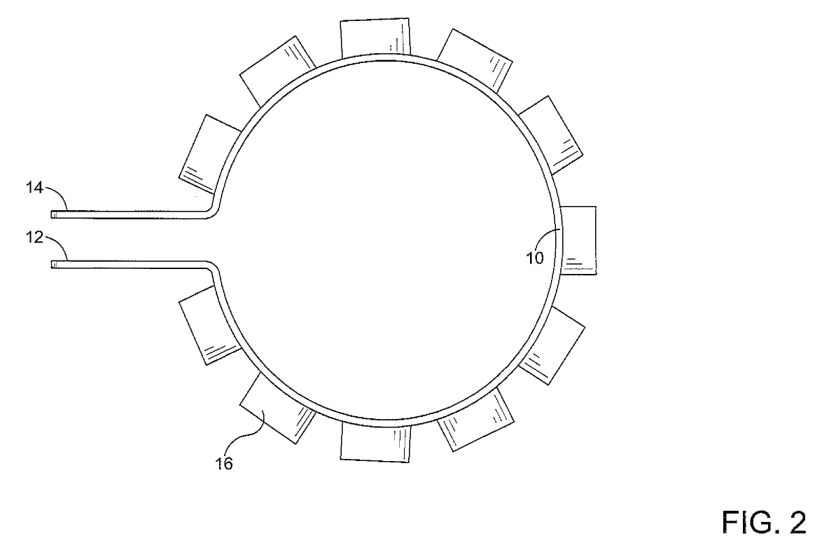

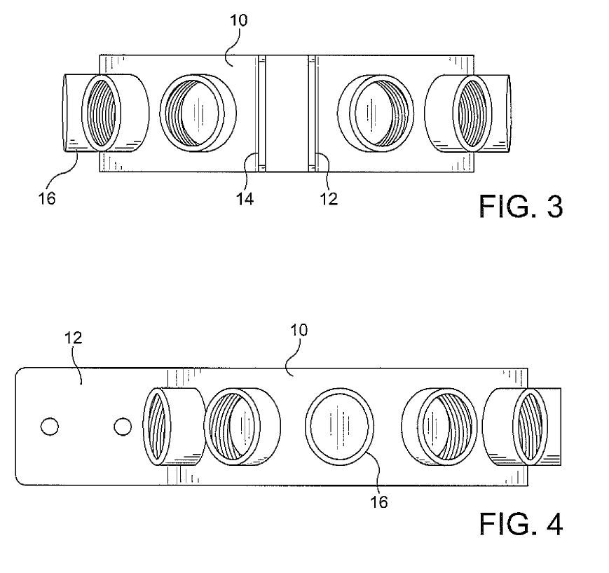

In a preferred embodiment the collar 10 is comprised of a metallic strip terminating at each end with outwardly extending lugs 12 and 14. Typically, each of the lugs 12 and 14 is provided with pairs of aligned openings or apertures for receiving suitable fasteners. It will be understood that the installation of the collar 10 on a supporting structure commences with a positioning of the collar 10 around the supporting structure and urging the lugs 12 and 14 toward one another to cause the apertures therein to align with respective apertures to permit the intertwined threaded fasteners, such as threaded fasteners, as illustrated in FIG. 1, for example.

The outer surface of the collar 10 includes a plurality of outstanding internally threaded sockets 16. The sockets 16 are typically welded in spaced relation about the outer peripheral surface of the collar 10. The invention is not to be limited to any particular disposition of the sockets 16, preferably the sockets 16 are spaced apart from one another in equal distances. It will be understood that the invention is not limited to any particular inclination of the longitudinal axis of the individual sockets 16. Typically, the axis of each of the sockets 16, is generally perpendicular to the outer surface of the collar 10 and the longitudinal axis of the collar 10.

Further, it will be understood that the material from which the collar 10 is formed may be sufficiently malleable and spring-like to allow the lugs 12 and 14 to be separated an amount to permit the collar 10 to span a supporting tree trunk, mast, or pole, and once in place to return to the original shape to be coupled for support. In this manner, the collar 10 may be secured to the supporting means.

Typically, after the collar 10 is secured to the supporting member, the ends of streamer staff are threadably received within the respective socket 16.

While it has been found that satisfactory results may be achieved by forming the collar 10 and the associated sockets 16 from a metal, other materials, such as, for example, plastic material may be used.

It will also be understood that the sockets 16 could employ other configurations for securing the ends of the streamer staffs. For example, threaded apertures could be provided extending perpendicular to the longitudinal axis of the sockets 16 to receive the threaded shank of a threaded fastener of the type used in many types of flag staff supports.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A streamer staff holder comprising:
an adjustable collar for surrounding a columnar support; and
a plurality of sockets affixed to an outer surface of the collar for holding an end of a streamer staff.

2. The invention defined in claim 1 wherein the collar is formed of a malleable material.

3. The invention defined in claim 1 whereas the collar is formed of a spring-like material.

4. The invention defined in claim 1 wherein the collar is in the form of a strap having normally spaced apart end portions.

5. The invention defined in claim 4 wherein the end portions of the collar are provided with apertures for receiving threaded fastener means.

6. The invention defined in claim 4 wherein the end portions of the collar may be selectively moved toward one another.

7. The invention defined in claim 1 wherein the sockets are welded thereto and caused to extend outwardly therefrom.

8. The invention defined in claim 1 wherein the collar has a longitudinal axis.

9. The invention defined in claim 1 wherein the sockets have respective longitudinal axes.

10. The invention defined in claim 9 wherein the longitudinal axes of the sockets are generally perpendicular to the longitudinal axis of the collar.
